(19) United States
(12) Patent Application Publication
(10) Pub. No.: US 2021/0350405 A1
(43) Pub. Date: Nov. 11, 2021

(54) Computer-Implemented Method for Generating Prescription Drug Price Ratios and Discounts for a Virtual System

(71) Applicant: Ezrirx LLC, Lakewood, NJ (US)

(72) Inventor: Ezriel Green, Lakewood, NJ (US)

(73) Assignee: Ezrirx LLC, Lakewood, NJ (US)

(21) Appl. No.: 17/316,365

(22) Filed: May 10, 2021

Related U.S. Application Data
(60) Provisional application No. 63/022,278, filed on May 8, 2020.

(51) Int. Cl. G06Q 30/02; G06Q 30/06

(52) U.S. Cl. CPC G06Q 30/0239; G06Q 30/0633; G06Q 30/0206

(57) ABSTRACT

A computer-implemented method for generating prescription drug price ratios and discounts includes generating, by a computer, a profile for a purchaser that accesses a QGF, the profile generated based on static information representing a margin for one or more generic pharmaceuticals corresponding to the purchaser, and based on dynamic information provided by a seller and the purchaser representing a digital cart; applying, by the computer, a plurality of analytics on the profile corresponding to the purchaser to generate a set of quantity and type of generic pharmaceuticals for purchasing for maximizing a corresponding discount on brand pharmaceuticals; generating, by the computer, a suggested generic pharmaceutical purchase alert in response to the set of quantity and type of generic pharmaceuticals for purchasing; and sending, by the computer, the suggested generic pharmaceutical purchase alert to the purchaser prompting the purchaser to add one or more generic pharmaceuticals to the digital cart.

### RELATED APPLICATION

This application claims priority to and incorporates entirely by reference U.S. Provisional Patent Application Ser. No. 63/022,278 filed on May 8, 2020.

### BACKGROUND OF THE INVENTION

### Field of the Invention

In one aspect, the present disclosure is relevant to a computer-implemented method for generating prescription drug price ratios and discounts as part of a virtual system.

### Description of the Background

At a high level, the United States pharmaceutical industry is divided into two general branches of pharmaceutical products, including (1) brand/specialty pharmaceuticals (“Brands”) and (2) generics/bio-similar pharmaceuticals (“Generics”). From a financial prospective, the overall expenditure on pharmaceuticals in the US leans 80% toward Brands and 20% toward Generics, while the usage is 20% on Brands and 80% on Generics. From a pharmaceutical industry profitability prospective, the manufacturers of Brands profit the most as they control the highest priced tier of product. Consequently, while distributors and pharmacies spend more on Brands, due to the associated margins, overall profit is typically made via the amount of money distributors and pharmacies profit on Generics.

Distributors are forced to stock brand pharmaceuticals to supply pharmacies, but essentially buy it at a few percent off Wholesale Acquisition Cost (WAC) and sell it to pharmacies at, often, lower prices than what they paid for it. Distributors then make up the losses by up-charging pharmacies on the Generics.

With Generic deflation taking place in the US today, the number of Generics a pharmacy has to buy in order to afford the discount allotted to them on the Brands is becoming increasingly difficult and wholesalers are using various tactics to enforce compliance from each pharmacy. Wholesalers offer rebates, discounts and other ways to get pharmacies to spend more money each month on Generics to reward pharmacies with a greater discount on Brands along with a rebate on Generics.

Pharmacies, in turn, often operate not knowing what their exact discount and rebate values are and, therefore, often overspend, while wholesalers count on pharmacies reaching their sales requirements for Generics in order to make up for the losses attributable to the Brands. This has become a convoluted problem, and pharmacies are left overspending on Generics, missing the targets set for them each month.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY OF THE INVENTION

In accordance with one form of the invention, there is provided a computer-implemented method for generating prescription drug price ratios and discounts, the computer-implemented method including generating, by a computer, a profile for a purchaser that accesses a Qualifying Generics File, the profile generated based on static information representing a margin for one or more generic pharmaceuticals corresponding to the purchaser, and based on dynamic information provided by a seller and the purchaser representing a digital cart; applying, by the computer, a plurality of analytics on the profile corresponding to the purchaser to generate a set of quantity and type of generic pharmaceuticals for purchasing for maximizing a corresponding discount on brand pharmaceuticals; generating, by the computer, a suggested generic pharmaceutical purchase alert in response to the set of quantity and type of generic pharmaceuticals for purchasing; sending, by the computer, the suggested generic pharmaceutical purchase alert to the purchaser prompting the purchaser to add one or more generic pharmaceuticals to the digital cart; receiving, by the computer, information corresponding to the one or more generic pharmaceuticals added to the digital cart; and applying, by the computer, the a plurality of analytics on the profile corresponding to the purchaser to generate a set of quantity and type of generic pharmaceuticals for purchasing for maximizing a corresponding discount on brand pharmaceuticals, wherein the static information representing the margin for one or more generic pharmaceuticals includes: information relating to which generic pharmaceuticals have a sufficient profit margin to offer a discount on brand pharmaceutical products; and information relating to qualified generic pharmaceutical products for entry into the Qualifying Generics File.

### BRIEF DESCRIPTION OF THE DRAWINGS

In the non-limiting embodiments discussed herein, like numerals indicate like elements in the Drawing, wherein:

FIG. 1 is a flowchart illustrating a process for computer-implemented method for generating prescription drug price ratios and discounts in accordance with an illustrative embodiment.

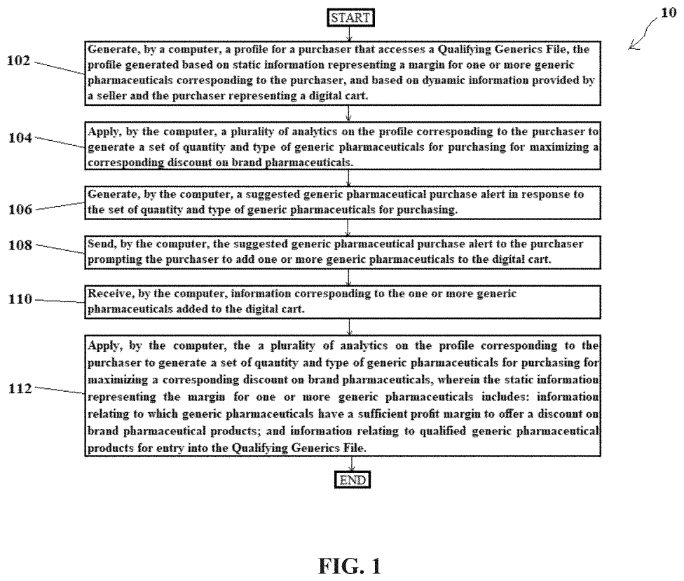

### DETAILED DESCRIPTION

Referring to the several views of the drawings, the computer-implemented method for generating prescription drug price ratios and discounts of the present invention is shown and is generally indicated as 10. Such a computer-implemented method would be beneficial for pharmacies to reduce time spent, in part, determining its discount on Brands.

Accordingly, a computer-implemented method 10 for generating prescription drug price ratios and discounts is provided for providing pharmacies in real time the Generics they are making a higher percentage on and thus allocating a larger discount for on the Brands, and give pharmacies a real-time guide for determining on a daily basis what products the pharmacies need to buy in order to obtain a bigger discount on their Brands. This will allow wholesalers to sell more of what is important to them, and allow pharmacies to (1) know exactly what items makes sense for them to buy and (2) not have to worry every day whether or not they will reach their Brand discounts requirements.

As pharmacies shop for a prescription, they add brand name products and generic products to their cart. At this time, the computer-implemented method for generating prescription drug price ratios and discounts displays to the pharmacies in real-time that (1) it can add a certain number more Generics to its count to achieve a discount on the Brands its purchases and (2) based on the Generics currently in its cart, whether it qualifies for (y) discount on a (z) dollar amount of Brands.

In operation, the computer-implemented method 10 for generating prescription drug price ratios and discounts, the computer-implemented method includes generating, by a computer, a profile for a purchaser that accesses a Qualifying Generics File, the profile generated based on static information representing a margin for one or more generic pharmaceuticals corresponding to the purchaser, and based on dynamic information provided by a seller and the purchaser representing a digital cart (step 102); applying, by the computer, a plurality of analytics on the profile corresponding to the purchaser to generate a set of quantity and type of generic pharmaceuticals for purchasing for maximizing a corresponding discount on brand pharmaceuticals (step 104); generating, by the computer, a suggested generic pharmaceutical purchase alert in response to the set of quantity and type of generic pharmaceuticals for purchasing (step 106); sending, by the computer, the suggested generic pharmaceutical purchase alert to the purchaser prompting the purchaser to add one or more generic pharmaceuticals to the digital cart (step 108); receiving, by the computer, information corresponding to the one or more generic pharmaceuticals added to the digital cart (step 110); and applying, by the computer, the a plurality of analytics on the profile corresponding to the purchaser to generate a set of quantity and type of generic pharmaceuticals for purchasing for maximizing a corresponding discount on brand pharmaceuticals, wherein the static information representing the margin for one or more generic pharmaceuticals includes: information relating to which generic pharmaceuticals have a sufficient profit margin to offer a discount on brand pharmaceutical products; and information relating to qualified generic pharmaceutical products for entry into the Qualifying Generics File (step 112).

Wholesaler input data will include a list of qualified Generics, which will be stored on a database. It will be assumed that the qualified Generics each constitutes a 20% profit margin. In one embodiment, the qualifying generics file will be a CSV file so that the data can be parsed in order to store the discounts being currently offered on the qualifying Generics.

In one embodiment, the Wholesaler selects products for which their profit margins are high enough to offer a discount on Brand products and provides the list of qualifying Generics for entry into the database. In one embodiment, the Wholesaler provides the list in the form of a Qualifying Generics File (“QGF”).

In accordance with the computer-implemented method of the present invention, the pharmacy takes the following steps:

(1) Pharmacies browse products and add products to their cart.

(2) Carts for “participating wholesalers” (i.e. wholesalers who have provided a QGF) will perform a live calculation to determine whether the pharmacy has achieved a discount on Brands based on the Generics it has in the cart. This calculation is based on the information provided in the QGF. For example, Product with NDC 00009-0233-01 and SKU 245421 will earn up to a 2% discount on up to $1000 worth of brands. There can also be multiple rules for the same product, e.g. along with the above discount rule, you could also have a rule of: Product with NDC 00009-0233-01 and SKU 24542 will earn up to 4% on up to $1500 worth of Brands.

(3)(a) If the live calculations have determined that the user is eligible for a discount, this is automatically stated to the user in the cart and applied to the line item. Discounts on multiple items can also exist in the same cart—the sum of the discounts earned is by $ and not %, so for example, a 2% and 4% discount earned cannot be 6% total discount applied, it needs to be by $: Product A: 2% of $1000 ($20)+Product B: 4% of $1500 ($60)=$80 total discount.

(3)(b) If the user is not eligible for a discount, a message informs the user how far away they are from a discount and prompts them to add more Generics to their cart to earn a discount on Brands. In one embodiment, the “Add more” tab is included with a message to add more Generics to the user's cart along with a Brands/Generics filter. In one embodiment, the “Add More” tab applies to generic products included in the pharmacy's QGF.

At the marketplace level, pharmacies browse products in the Marketplace and click to view the products. In the wholesalers' section of the product view (product details view modal, product view page), the system displays for each wholesaler the discount that would be achieved if the user added the product to their carts.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

1. A computer-implemented method for generating prescription drug price ratios and discounts, the computer-implemented method comprising:
generating, by a computer, a profile for a purchaser that accesses a Qualifying Generics File, the profile generated based on static information representing a margin for one or more generic pharmaceuticals corresponding to the purchaser, and based on dynamic information provided by a seller and the purchaser representing a digital cart;
applying, by the computer, a plurality of analytics on the profile corresponding to the purchaser to generate a set of quantity and type of generic pharmaceuticals for purchasing for maximizing a corresponding discount on brand pharmaceuticals;
generating, by the computer, a suggested generic pharmaceutical purchase alert in response to the set of quantity and type of generic pharmaceuticals for purchasing;
sending, by the computer, the suggested generic pharmaceutical purchase alert to the purchaser prompting the purchaser to add one or more generic pharmaceuticals to the digital cart;
receiving, by the computer, information corresponding to the one or more generic pharmaceuticals added to the digital cart; and
applying, by the computer, the a plurality of analytics on the profile corresponding to the purchaser to generate a set of quantity and type of generic pharmaceuticals for purchasing for maximizing a corresponding discount on brand pharmaceuticals, wherein the static information representing the margin for one or more generic pharmaceuticals includes: information relating to which generic pharmaceuticals have a sufficient profit margin to offer a discount on brand pharmaceutical products; and information relating to qualified generic pharmaceutical products for entry into the Qualifying Generics File.
